(19) United States
(12) Patent Application Publication
(10) Pub. No.: US 2020/0009814 A1
(43) Pub. Date: Jan. 9, 2020

(54) TIRE CURING MEMBRANE AND PROCESS

(71) Applicant: Compagnie Generale Des Etablissements Michelin, Clermont-Ferrand (FR)

(72) Inventors: Frédéric Pialot, Clermont-Ferrand (FR); Damien Fombelle, Clermont-Ferrand (FR); Thomas Simonelli, Clermont-Ferrand (FR)

(21) Appl. No.: 16/487,135

(22) PCT Filed: Mar. 29, 2018
(86) PCT No.: PCT/FR2018/050785

§ 371 Date: Aug. 20, 2019

(30) Foreign Application Priority Data
Mar. 30, 2017 (FR) 1752722

(51) Int. Cl. B29D 30/06; B29C 33/50

(52) U.S. Cl. CPC B29D 30/0654; B29D 2030/0655; B29D 2030/0647; B29C 33/505

(57) ABSTRACT

The curing bladder for a tire comprises a body made of a flexible material suited to being inserted in the drawn-in position inside a pneumatic tire in a curing mould and which is capable of being expanded so as to flatten the tire against the internal surface of the mould. The body is produced based on a film made of a thermoplastic polymer and has a cylindrical tube shape when the bladder is in the drawn-in position.

### CROSS-REFERENCE TO RELATED APPLICATION

The present application claims priority to PCT International Patent Application No. PCT/FR2018/050785, filed Mar. 29, 2018, which claims priority to FR 1752722, filed Mar. 30, 2017.

### BACKGROUND OF THE INVENTION

### 1. Field of the Invention

The present invention relates to the field of tires and concerns curing bladders used in processes for the manufacture of tires.

### 2. Related Art

Tires are generally obtained by moulding and vulcanization of a raw casing inside a mould installed in a curing press. The external walls of the casing are flattened against the internal metal walls of the curing mould by means of a curing bladder which is itself expandable under the effect of a pressurized heat-exchange fluid. The pattern of the tread of the fittings of the mould and that of the dies is then stamped onto the raw casing, which is subsequently vulcanized using heat.

The curing bladder is opened out inside the raw casing, before the curing, and it is drawn in again, at the end, inside the mould. The curing bladder comprises, for this purpose, a flexible body produced by vulcanization made of a rubber of butyl type. The exterior surface of the bladder exhibits grooves for discharge of air and a certain texture for improving the visual appearance of the inside of the tire. During the curing of a tire, the body of the bladder is highly stressed in tension/compression, under the action of the fluid inside the bladder, but also in friction in contact with the tire. Moreover, the bladder operates at high temperatures. Furthermore, a curing bladder is required to withstand mechanical and thermal stresses during a certain number of curing cycles, which is usually a few hundred. In view of all these constraints, the walls of the bladder have to exhibit a certain thickness which is, in its thinnest central part, for a passenger vehicle tire, for example, between 4 and 6 mm.

In point of fact, it has been found that such a thick bladder made of rubber, which is thus thermally insulating, acts as a screen for the thermal energy which has to pass through it during the curing before reaching the tire.

The document CN 201220641037 introduces a solution to this problem by providing a thin curing bladder. The bladder according to this document exhibits a flexible body, the wall of which has a thickness of 3 mm except at the heels, where the thickness is 3.5 mm. While admittedly exhibiting a better thermal conductivity than the usual curing bladders, the curing time under pressure of the tire is not, however, significantly reduced.

In order for the bladder to be able to be suitable for the geometry of the different tires and for the dimensions of the bladder support platens within the curing presses, it has to be accordingly proportioned. For this reason, a great diversity of curing bladders are encountered in the industry, which requires a high storage capacity and appropriate logistics within the curing workshop. Furthermore, the bladders have to be treated in order for them to become supple before a first use, which requires an additional preparation time for them. Moreover, in order to prevent the bladder from sticking to the tire, the latter has to be treated by coating with a non-stick product before introducing it into the curing mould. This involves additional handling operations on the pneumatic tire before the curing which are expensive and take time.

In order to overcome these problems, the document EP 1 024 946 provides a curing mould for tires which is devoid of curing bladder. The mould according to this document comprises sealing rings which come into contact with the heels of the tire during the curing in order to provide the sealing of the pressurized heat-exchange fluid inside the tire. While admittedly exhibiting an optimized pressurized curing time, it turns out, however, that a bladder-free curing presents moulding problems which are due mainly to the penetration of the pressurized heat-exchange fluid into the rubber layers. Other moulding problems have also been observed, and appeared in particular at the welds of the plies or beads. The appearance of creep of the rubbers of the different plies through the threads of the carcass ply has also been observed.

### SUMMARY OF THE INVENTION

One objective of the disclosure is overcome the disadvantages of the abovementioned documents and to contribute a novel solution in order to make it possible to reduce the duration of the pressurized curing of a tire while making it possible to obtain a tire of excellent quality.

This aim is achieved by the disclosure, which provides a curing bladder for a tire comprising a body made of a flexible material suited to being inserted in the drawn-in position inside a pneumatic tire in a curing mould and which is capable of being expanded so as to flatten the tire against the internal surface of the mould, wherein the said body is produced based on a film made of a thermoplastic polymer and has a cylindrical tube shape when the bladder is in the drawn-in position.

According to the disclosure, the thick curing bladder, made of butyl rubber, of the state of the art is replaced with a curing bladder which is very thin, being produced from a film made of a thermoplastic polymer. Film made of a thermoplastic polymer is understood to mean a flexible film resistant to the heat of the curing which is produced in the form of a thin layer or a film. The body of the bladder has a cylindrical tube shape when the bladder is in the drawn-in position before the curing or before the injection of the pressurized heat-exchange fluid inside the mould. Such a film is chosen so as to exhibit good properties of extensibility allowing it to be deformed and to assume a toric shape under the pressure of the heat-exchange fluid introduced inside the bladder when the raw tire is placed in a curing mould.

It has thus been found, during tests carried out in the laboratory, that the pressurized curing time of a passenger vehicle tire was reduced by approximately 10%, as the energy transported by the heat-exchange fluid very rapidly reaches the tire, the thickness of the film being markedly less than that of an ordinary bladder. Moreover, such a polymer film withstands greater curing temperatures than those of a bladder made of butyl rubber and, for this reason, it makes possible curing at high temperatures, for example of the order of 150° C. to 180° C.

Preferably, the said film made of a thermoplastic polymer is of the non-stick type.

The said film preferably exhibits a limited adhesion to the tire, indeed even to the innermost rubber layer of the latter, in order to be able to be detached therefrom. Non-stick is understood to mean that the peel force of the film of the tire is preferably less than 1 N/mm and very preferably less than 0.5 N/mm at 20° C.

Advantageously, the said film is chosen from the group of the films comprising at least one fluoropolymer. Fluoropolymers exhibit excellent non-stick properties.

Preferably, the fluoropolymer is selected from the group of the polymers consisting of a fluorinated ethylene/propylene copolymer (FEP), a perfluoroalkoxy (PFA), an ethylene/tetrafluoroethylene copolymer (ETFE), a polytetrafluoroethylene (PTFE) and their mixtures.

In a preferred embodiment of the disclosure, the body of the bladder is produced from a film made of a thermoplastic polymer which is fixed to the bladder support platens provided for this purpose in a curing press. By producing the bladder made of a film of fluoropolymer selected from the group of the polymers consisting of FEP, PFA, ETFE and PTFE, success is achieved in easily detaching the bladder from the tire without having to carry out a stage of coating the raw tire with a non-stick product prior to the curing.

It was also found that, by using such a film, the tire was well moulded in every respect without the plies having undergone relative displacement or creep. It was observed, surprisingly, that, even using a smooth (untextured) film, thus in the absence of grooves for discharge of air on the bladder, the tire was well moulded, the interior appearance of the tire thus being very smooth. This is due to the sliding ability of the polymer film, the occluded air managing to slide along the wall of the film as the bladder is opened out.

Preferably, the thickness of the said film is less than 0.1 mm and more preferably still the thickness of the said film is between 25 and 50 μm.

A film of this thickness is sufficiently thin not to be thermally inert while having a good resistance to mechanical stresses.

Advantageously, the said film is extendable in several directions and it has an elongation capacity of at least 300% in each direction.

Several directions is understood to mean at least the direction of drawing of the film during its manufacture (flat or tube) and a direction perpendicular to this direction. This makes it possible for the bladder to stretch out, taking the shape of a torus, and to subsequently be drawn in again, this being the case during several curing cycles. Furthermore, such a film, which has a high ability to deform, makes it possible to be suitable for different tire dimensions and, for this reason, to reduce the number of references of curing bladders necessary in a factory.

Preferably, the thermal conductivity of the said film is greater than 0.1 W/m/K.

Advantageously, the said body has a tubular general shape and its dimensions are chosen as a function of those of the pneumatic tire to be cured, so that the diameter of the said body is less than the internal diameter of the pneumatic tire and the length at least equal to the distance between its bead wires.

Such a bladder can then be suitable, due to the deformation of the tubular film, for several dimensions of tires.

The objective of the disclosure is also achieved with a device for vulcanization of a tire using a curing mould and a heat-exchange fluid which acts through a curing bladder in order to flatten the pneumatic tire against the internal surface of the mould, in which the bladder is produced according to the disclosure.

Another subject-matter of the disclosure is a process for the manufacture of a tire, comprising the following stages:
a raw pneumatic tire is prepared by assembling, on a rotating drum, at least: a gastight internal layer, a carcass ply, a reinforcing ply and a tread and by shaping into the shape of a torus;
the tire is placed in a curing mould;
the tire is cured using a heat-exchange fluid introduced inside the curing mould in order to flatten the said tire against the internal surface of the mould by acting on the internal face of an expandable bladder produced based on a film made of a thermoplastic polymer and comprising a body which has a cylindrical tube shape when the bladder is in the drawn-in position, before the curing.

### BRIEF DESCRIPTION OF THE DRAWINGS

A better understanding of the disclosure will be obtained by virtue of the continuation of the description, which is based on the following figures:

FIGS. 1a to 1c illustrate, by sectional half-views, the phases of the opening out of a curing bladder inside a mould according to the state of the art;

FIG. 2 is a diagrammatic sectional view of a curing mould comprising a bladder according to the state of the art;

FIG. 3 is a diagrammatic sectional view of a curing mould comprising a curing bladder according to the disclosure;

FIG. 4 is a view on a magnified scale of the detail D of FIG. 3;

FIGS. 5a and 5b are perspective views illustrating curing bladders of the disclosure;

FIGS. 6a to 6c diagrammatically illustrate examples of proportioning of the bladders of the disclosure for different tires.

### DETAILED DESCRIPTION OF THE ENABLING EMBODIMENTS

In the different figures, identical or similar elements carry the same reference. Their description is thus not systematically repeated.

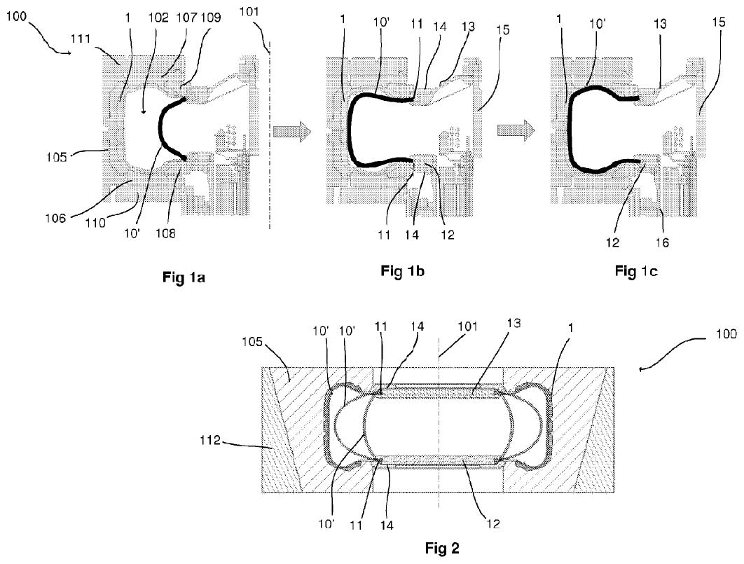

In order to give a better description of the disclosure, the different phases of opening out a curing bladder 10′ of the state of the art inside a raw pneumatic tire 1 (or tire blank) positioned in a curing mould 100 have been represented in FIGS. 1a to 1c. The curing mould 100 exhibits a general shape of symmetry of revolution of central axis 101 and the tire 1 is centred on the latter. The curing mould is positioned inside a curing press which actuates the closing/opening of the mould and feeds with heat-exchange fluid.

In that which follows, an axial direction denotes a direction parallel to the central axis 101 of the mould, a radial direction denotes a direction perpendicular to the central axis, a radial plane denotes a plane containing the central axis and a radial direction, and a circumferential direction denotes a direction perpendicular to the radial plane.

A pneumatic tire is obtained by stacking different rubber-based plies and different components on a rotating drum, followed by a shaping of the assembly into a toroidal shape. The plies applied to the drum in order to obtain a tire of radial type are, in order: a ply of butyl rubber which forms the internal rubber airtight to the inflation gas, a carcass ply based on reinforcing threads embedded in the rubber, which ensures the mechanical strength of the tire, followed by the arranging of the bead wires, optionally of the bead-wire filling profiled elements, subsequently of the sidewalls, of the reinforcing belt and of the tread. Once shaped into the form of a torus, the tire is placed inside a curing mould, the internal cavity of which exhibits the shape and the dimensions of the finished tire.

FIG. 1a illustrates the tire positioned inside the mould, the latter being closed and the bladder not opened out. FIG. 1b illustrates the following stage, during which the pressurized heat-exchange fluid begins to be introduced and the bladder begins to open out inside the tire, the curing not yet having begun. FIG. 1c illustrates the completely opened-out position of the bladder, the tire being pushed by the bladder and being found in contact with the internal surface of the mould, which position corresponds to the curing phase.

More particularly, the mould 100 comprises several sectors 105 positioned side by side in the circumferential direction. The internal surface of the sectors defines, with that of the dies 106, 107 and of the moulding rings of the beads 108, 109, an internal cavity 102 receiving the tire within the mould. The mould is opened, respectively closed, by axial displacement of at least one of the platens 110, 111 of the curing press and radial displacement of the sectors 105 of the mould. The curing mould is of the known type and is not described in more detail.

The curing bladder 10′ comprises a body of tubular general shape which is mounted by its longitudinal ends on a support within the press. The curing bladder 10′ thus comprises a body 10′a provided with two heels 11 which are anchored to two bladder support platens 12 and 13 by virtue of two flanges 14. A rod 15 mounted in sliding fashion displaces one bladder support platen with respect to the other in order to make possible the opening out and the drawing in of the bladder 10′ and to be able to separate it from the cured tire. The bladder contains the heat-exchange fluid, which is, for example, steam or a neutral gas, such as nitrogen. The heat-exchange fluid is introduced inside the bladder and extracted from the latter via a pipe 16. In operation, the bladder is opened out inside the tire and it is drawn in until it is present in the space located radially inside the beads.

FIG. 2 diagrammatically illustrates, by a sectional view, a mould 100 comprising sectors 105, a hooping ring 112 for radially displacing the sectors and a bladder 10′ of the state of the art. The bladder 10′ is illustrated in 3 positions: a first position in which it is drawn in inside the beads, an intermediate position of opening out inside the pneumatic tire, which corresponds to the start of injection of heat-exchange fluid, and a final position in which it flattens the tire against the internal surface of the mould 100 and which corresponds to the curing stage.

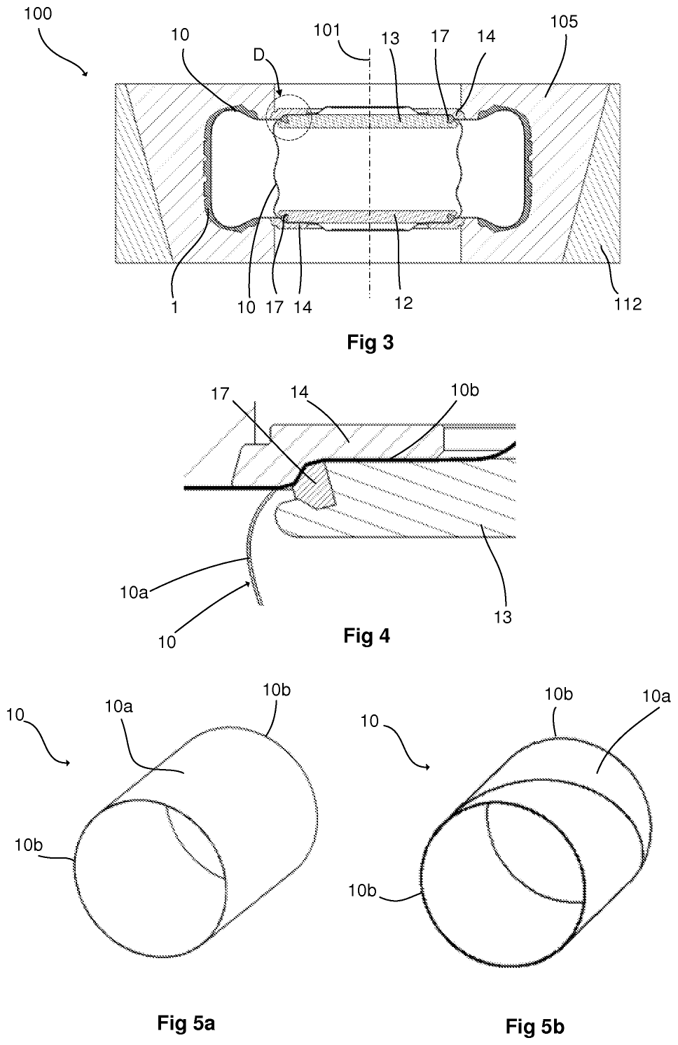

FIG. 3 illustrates the mould 100 of FIG. 2 comprising a bladder 10 in accordance with the disclosure. The bladder 10 is illustrated in two operating positions: a drawn-in position inside the space located between the beads of the tire, in which position the tire can be displaced with respect to the mould, and a completely expanded position, which corresponds to the position which it takes during the curing of the tire. According to the disclosure, the body 10a of the bladder 10 is produced based on a film made of a thermoplastic polymer which, in the drawn-in position of the bladder, before the curing, has a tubular shape of circular section.

According to an advantageous aspect of the disclosure, the said film is chosen from the group of the films comprising at least one fluoropolymer.

Preferably, the said polymer comprises a fluorinated ethylene/propylene copolymer (FEP). Such a film has the property of good temperature resistance and exhibits very good nonstick properties (it is often used for the crosslinking of composites). It is very flexible, being extendable with a low stiffness, and has a plastic behaviour, it has a very low coefficient of friction, it is non-hygroscopic (water absorption <0.01%) and it exhibits an operating temperature ranging up to +205° C., which is greater than the vulcanization temperature of the pneumatic tire.

By way of example, such a film is Vacfilm® 800G from Cytec or A5000 from the same company.

Other films are also suitable in the context of the invention, for example the FEP/PFA Teflon™ fluorinated films from Micel or the bagging films PO180, PO180 Tube or PA205 from Diatex.

In an advantageous alternative form of the disclosure, the film is textured in order to make possible better draining of the gases trapped between the tire and the bladder during the curing. Such a film is, for example, the PA205 HF film from Diatex.

The tests carried out in the laboratory with a bladder of the invention produced based on fluorinated films, such as Tedlar® (polyvinyl fluoride) or Kynar® (polyvinyl fluoride) from Technifilm, a company of the ADDEV Materials group, in the context of the invention have given good results.

As clear in FIGS. 5a and 5b, the body 10a of the bladder 10 is tubular of circular section between its longitudinal ends 10b. The bladder of FIG. 5a is obtained by extrusion of a tube made of a thermoplastic polymer. The bladder of FIG. 5b is obtained by cutting and welding a flat film made of a thermoplastic polymer and also has a cylindrical tube of circular cross-section shape.

The bladder of FIGS. 5a and 5b is fixed to the bladder platens 12 and 13 using flanges 14 and blocks 17. The blocks 17 are, in an alternative form, produced in a similar way to the heels 11, that is to say that they are produced made of rubber and have an annular shape and a wedge-shaped or inclined axial section. Unlike the fixing method illustrated in FIG. 2, the blocks 17 are integral with the platen 12, respectively 13, being permanently fixed to the latter so as to sandwich, over a predetermined length and against the facing surface of the flange 14, the longitudinal end 10b of the bladder. The bladder 10 is thus fixed by its ends 10b in an airtight way to the platens 12, 13.

The thickness of the film which constitutes the body of the bladder is less than 0.1 mm and it is preferably between 25 and 50 μm. The film is extendable in several directions, including at least that of drawing of the flat film or of the tube film, and it has an elongation capacity of at least 300% in each of these directions. Furthermore, the thermal conductivity of the said film is greater than 0.1 W/m/K. Such a film makes it possible to substantially reduce the curing time of the tire and to withstand curing temperatures of between 120° C. and 180° C. and the pressure exerted by the heat-exchange fluid, of between 10 and 30 bars.

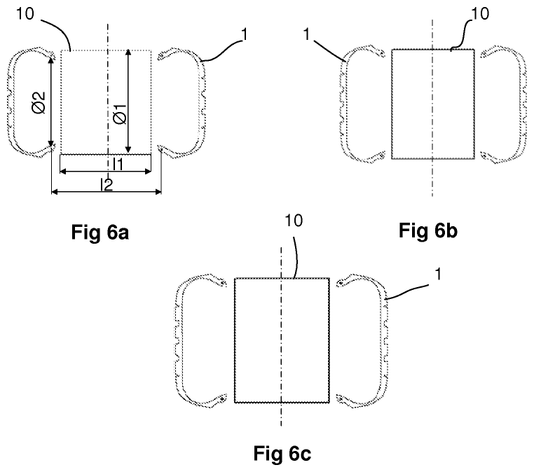

The dimensions of the bladder 10 are chosen in connection with the dimensions of the tire to be cured. FIGS. 6a and 6b illustrate a few examples of proportioning of a bladder 10 of the invention. In the figures, Ø1 has denoted the external diameter of the bladder, Ø2 has denoted the diameter of the seat, which corresponds to the diameter at the beads, l1 has denoted the length of the bladder and l2 has denoted the “bead wire separation” or the distance between the beads of the tire.

Thus, the bladder of FIG. 6a has a diameter Ø1 which is slightly less than Ø2 for a length l1 which is close to l2. By way of example, for a 225/55/16 tire, the bladder has a diameter of 400 mm and a length of 250 mm. It is the same for the bladder of FIG. 6b, which applies to a 305/55/16 tire, and it has a diameter of 400 mm and a length of 350 mm.

The bladder of FIG. 6c has a diameter Ø1 which is much less than Ø2 for a length l1 which is greater than l2. By way of example, for a 225/55/18 tire, the bladder has a diameter of 450 mm and a length of 350 mm.

Thus, due to the high ability to deform of the film which constitutes it, a bladder of the disclosure of given dimensions can be used with a greater variety of tire dimensions. For this reason, the number of references of bladders is much more limited compared with that of the bladders made of butyl rubber of the state of the art.

In operation, a bladder 10 of the invention is arranged on a curing press, inside and so as to interact with a curing mould 100, being centred on the axis 101 of the latter. A pneumatic tire 1 is introduced inside the mould and the mould is closed. The pressurized heat-exchange fluid is injected into the bladder 10, which deforms and flattens the tire against the internal surface of the mould. The curing of the tire ensues over a markedly shorter curing time than that carried out using a bladder made of butyl rubber of the state of the art. The mould 100 is opened and the cured tire is extracted therefrom. The bladder 10 of the invention remains in place for the following curing, which repeats the same cycle.

Other alternative forms and embodiments of the disclosure can be envisaged without departing from the scope of its claims.

Thus, it is possible to use another means of fixing the longitudinal ends of the bladder to the support platens of the press, in particular by using rapid fixing means, for example by means of direct fixing rings on the platens, in order for each to trap one of the ends of the bladder.

It is also possible to envisage the use of a film comprising at least two layers, one of which (that which is intended for contact with the pneumatic tire) has non-stick properties.

1. A curing bladder for a tire comprising a body made of a flexible material suited to being inserted in the drawn-in position inside a pneumatic tire in a curing mould and which is capable of being expanded so as to flatten the tire against the internal surface of the mould, wherein the said body is produced based on a film made of a thermoplastic polymer and has a cylindrical tube shape when the bladder is in the drawn-in position.

2. The bladder according to claim 1, wherein the said film made of a thermoplastic polymer is of the non-stick type.

3. The bladder according to claim 1, wherein the said film is chosen from the group of the films comprising at least one fluoropolymer.

4. The bladder according to claim 3, wherein the fluoropolymer is selected from the group of the polymers consisting of a fluorinated ethylene/propylene copolymer (FEP), a perfluoroalkoxy (PFA), an ethylene/tetrafluoroethylene copolymer (ETFE), a polytetrafluoroethylene (PTFE) and their mixtures.

5. The bladder according to claim 1, wherein the thickness of the said film is less than 0.1 mm.

6. The bladder according to claim 1, wherein the thickness of the said film is between 25 and 50 μm.

7. The bladder according to claim 1, wherein the said film is extendable in several directions and it has an elongation capacity of at least 300% in each direction.

8. The bladder according to claim 1, wherein the thermal conductivity of the said film is greater than 0.1 W/m/K.

9. The bladder according to claim 1, wherein its dimensions are chosen as a function of those of the pneumatic tire to be cured, so that the diameter of the said body is less than the internal diameter of the pneumatic tire and the length at least equal to the distance between its bead wires.

10. A device for vulcanization of a tire using a curing mould and a heat-exchange fluid which acts through a curing bladder in order to flatten a pneumatic tire against the internal surface of the mould, wherein it comprises a bladder according to claim 1.

11. A tire manufacturing process, comprising the following stages:
a pneumatic tire is prepared by assembling, on a rotating drum, at least: a gastight interior rubber layer, a carcass ply, a reinforcing ply and a tread and by shaping into the shape of a torus;
the pneumatic tire is placed in a curing mould;
the tire is cured using a heat-exchange fluid introduced inside the curing mould in order to flatten the said tire against the internal surface of the mould by acting on the internal face of an expandable bladder produced based on a film made of a thermoplastic polymer and comprising a body which has a cylindrical tube shape when the bladder is in the drawn-in position, before the curing.
